(19) United States
(12) Patent Application Publication
(10) Pub. No.: US 2011/0055359 A1
(43) Pub. Date: Mar. 3, 2011

(54) INFORMATION PROCESSOR, CONTENTS RECORDING METHOD, PROGRAM, AND STORAGE MEDIUM

(75) Inventor: Eizaburo MURAKI, Tokyo (JP)

(73) Assignee: NEC Personal Products, Ltd.

(21) Appl. No.: 12/939,457

(22) Filed: Nov. 4, 2010

Related U.S. Application Data
(62) Division of application No. 11/091,489, filed on Mar. 29, 2005.

(30) Foreign Application Priority Data
Mar. 30, 2004 (JP) 2004-100289

(51) Int. Cl. G06F 15/16

(52) U.S. Cl. 709/219

(57) ABSTRACT

Provided are an information processor and a contents recording method, which enable to meet a particular demand of a user for storing contents. When a user interface receives a contents extracting condition which indicates a proportion of contents having a specific characteristic within a plurality of kinds of contents to be stored in a memory card, a contents transfer command unit stores the received contents extracting condition to a contents transfer condition information recording unit. The contents transfer command unit extracts the contents from a memory by satisfying the contents extracting condition, and records the extracted contents to the memory card through a memory card connecting section.

### CROSS-REFERENCE TO RELATED PATENT APPLICATIONS

This application is a divisional of application Ser. No. 11/091,489, filed Mar. 29, 2005, now pending, which claims the benefit of priority from the prior Japanese Patent Application No. 2004-100289, filed Mar. 30, 2004, the entire contents of which are incorporated herein by reference. This application claims only subject matter disclosed in the parent application and therefore presents no new matter.

### BACKGROUND OF THE INVENTION

1. Field of the Invention

The present invention relates to an information processor, a contents recording method, a program, and a storage medium and, more specifically, to an information processor, a contents recording method, a program, and a storage medium for recording contents selected from a plurality of kinds of contents onto a storage medium.

2. Description of the Related Art

Recently, a home server comprising a large capacity memory such as a personal computer (referred to as “PC” hereinafter) or a DVD (Digital Versatile Disk) recorder has come into wide use. A home server can store a vast amount of information (contents) such as a video, music, still picture and the like. On the contrary, the memory capacity of a portable terminal which can carry the contents is smaller than the memory capacity of the home server. Therefore, the portable terminal can store only a part of the contents stored in the home server.

For example, if a user of a portable terminal views or listens to the contents stored in the home server through the portable terminal while moving at the daily commuting time or the like, it is necessary for the user of the portable terminal to change the contents stored in the portable terminal frequently. Otherwise, the user has to view or listens to the same contents day after day.

When changing the contents to be stored in the portable terminal, the user of the portable terminal selects the desired contents from the contents stored in the home server and stores the selected contents onto the portable terminal, which is rather a complicated work.

Japanese Patent Unexamined Publication No. 2003-77214 discloses an information processor which enables to simplify a rewrite work for rewriting the contents written to a portable terminal to other contents.

Specifically, disclosed is the information processor in which, when storing the contents to a storage medium of the portable terminal, first, all the contents stored in the storage medium of the portable terminal is once deleted from the storage medium of the portable terminal, then, the contents corresponding to a prescribed condition which is set in advance by a user is extracted from a storage unit of a PC and the like to which a plurality of kinds of contents are stored, and the extracted contents are recorded in the storage medium of the portable terminal.

In the information processor disclosed in Japanese Patent Unexamined Publication No. 2003-77214, used as the prescribed condition are: recently listened music, music with less check-out times, music on a favorite play list, random selection of music, designated genre, designated play list, or the like.

However, with the contents extracting condition used in the information processor disclosed in Japanese Patent Unexamined Publication No. 2003-77214, there may be a case where it becomes difficult to extract the contents from the vast amount of the contents stored in the home server by sufficiently reflecting the intention of the user.

For example, with the contents extracting condition used in the information processor disclosed in Japanese Patent Unexamined Publication No. 2003-77214, it is difficult to reflect the user's intention to set the respective proportions of a plurality of kinds of contents with respect to the entire contents of a plurality of kinds which are to be recorded in the storage medium of the portable terminal.

Further, with the contents extracting condition used in the information processor disclosed in Japanese Patent Unexamined Publication No. 2003-77214, it is difficult to reflect the user's intention to automatically change the contents to be recorded in the storage medium of the portable terminal according to the external circumstances such as the weather.

Further, with the contents extracting condition used in the information processor disclosed in Japanese Patent Unexamined Publication No. 2003-77214, it may be difficult to reflect the user's intention to maintain the proportion of the contents to be recorded in the storage medium of the portable terminal to be the proportion of the kinds (for example, genre) of the contents which have been already stored in the storage medium of the portable terminal.

Further, in the information processor disclosed in Japanese Patent Unexamined Publication No. 2003-77214, for storing the contents to the storage medium of the portable terminal, all the contents stored in the storage medium of the portable terminal are deleted once from the storage medium of the portable terminal and, then, the contents corresponding to the prescribed condition are stored in the storage medium for the portable terminal. Therefore, it is highly possible that, for example, the unviewed/unlistened contents are deleted.

Furthermore, there is a time lag between the time of storing the contents to the storage medium and the time when the contents stored in the storage medium are viewed or listened. Thus, when the user listens to the contents stored in the storage medium, it is possible that the user may prefer to listen to the contents different from the ones selected at the time of storing the contents to the storage medium.

In the information processor disclosed in Japanese Patent Unexamined Publication No. 2003-77214, it is only the contents selected by the user at the time of storing the contents, which can be stored in the storage medium of the portable terminal. Therefore, in the information processor disclosed in Japanese Patent Unexamined Publication No. 2003-77214, it is not possible to sufficiently meet the demand of the user, which is to listen to the contents different from the ones selected at the time of storing the contents to the storage medium.

### SUMMARY OF THE INVENTION

An object of the present invention is to provide an information processor and a contents recording method which can meet a particular demand of the user for storing the contents.

In order to achieve the foregoing object, the information processor of the present invention is an information processor for recording a part of a plurality of kinds of contents being stored in a contents storage unit to a storage medium of a portable terminal, which comprises: an extracting condition storage unit for storing a contents extracting condition being set by a user, which indicates an amount of contents to be recorded in the storage medium and a proportion of contents by each kind; a contents extracting unit for extracting contents from a plurality of kinds of contents stored in the contents storage unit by satisfying the contents extracting condition stored in the extracting condition storage unit; and a recording unit for recording the contents extracted by the contents extracting unit to the storage medium of the portable terminal.

Further, the contents recording method of the present invention is a contents recording method performed by an information processor which records a part of a plurality of kinds of contents being stored in a contents storage unit to a storage medium of a portable terminal, and the method comprises: an extracting condition storing step for storing a contents extracting condition being set by a user, which indicates an amount of contents to be recorded in the storage medium and a proportion of contents by each kind to an extracting condition storage unit; a contents extracting step for extracting contents from a plurality of kinds of contents stored in the contents storage unit by satisfying the contents extracting condition stored in the extracting condition storage unit; and a recording step for recording the contents extracted in the contents extracting step to the storage medium of the portable terminal.

In the above-described present invention, the contents which are extracted from a plurality of kinds of contents stored in the contents storage unit in the amount of the contents to be recorded to the recording medium and the proportion of the contents by each kind set by the user are recorded to the storage medium of the portable terminal. Therefore, it enables to comply with the particular demand of the user for storing the contents, which is to set the proportion of the contents by each kind to be recorded to the storage medium of the portable terminal.

Further, it is desirable that, in a case where music is the contents, the kinds of contents be classified by a tempo of music, liveliness of music, bass state of music, listened times of music, sex of a singer, or a number of singers; and in a case where a picture is the contents, the kinds of contents be classified by a relation of closeness between a person in the picture and the user or a brightness of the picture.

Also, the information processor of the present invention is an information processor for recording a part of a plurality of kinds of contents being stored in a contents storage unit to a storage medium of a portable terminal, which comprises: an environment obtaining unit for obtaining environmental information indicating a surrounding environment; a contents extracting unit for extracting contents from a plurality of kinds of contents stored in the contents storage unit according to the environmental information obtained by the environment obtaining unit; and a recording unit for recording the contents extracted by the contents extracting unit to the storage medium of the portable terminal.

Further, the contents recording method of the present invention is a contents recording method performed by an information processor which records a part of a plurality of kinds of contents being stored in a contents storage unit to a storage medium of a portable terminal, the method comprising: an environment obtaining step for obtaining environmental information indicating a surrounding environment; a contents extracting step for extracting contents from a plurality of kinds of contents stored in the contents storage unit according to the environmental information obtained in the environment obtaining step; and a recording step for recording the contents extracted in the contents extracting step to the storage medium of the portable terminal.

In the above-described present invention, the contents which are extracted from a plurality of the contents stored in the contents storage unit according to the surrounding environment are recorded to the storage medium of the portable terminal. Therefore, it enables to comply with the particular demand of the user for storing the contents, which is to change the contents to be recorded to the storage medium of the portable terminal according to the change in the surrounding environment.

Further, it is desirable that the environmental information be weather information.

Further, the information processor of the present invention is an information processor for recording a part of a plurality of kinds of contents being stored in a contents storage unit to a storage medium of a portable terminal, which comprises: a kind detecting unit for detecting kinds of contents which are recorded in advance in the storage medium of the portable terminal; a contents extracting unit for extracting contents from a plurality of kinds of contents stored in the contents storage unit according to the kind detected by the kind detecting unit; and a recording unit for recording the contents extracted by the contents extracting unit to the storage medium of the portable terminal.

Furthermore, the contents recording method of the present invention is a contents recording method performed by an information processor for recording a part of a plurality of kinds of contents being stored in a contents storage unit to a storage medium of a portable terminal, and the method comprises: a kind detecting step for detecting kinds of contents which are recorded in advance in the storage medium of the portable terminal; a contents extracting step for extracting contents from a plurality of kinds of contents stored in the contents storage unit according to the kinds detected in the kind detecting step; and a recording step for recording the contents extracted in the contents extracting step to the storage medium of the portable terminal.

In the above-described present invention, the contents which are extracted from a plurality of kinds of the contents stored in the contents storage unit according to the kinds of the contents recorded in advance in the storage medium of the portable terminal are recorded to the storage medium of the portable terminal. Therefore, for example, it enable to comply with the particular demand of the user for storing the contents, which is to change the contents to be recorded to the storage medium of the portable terminal while keeping the proportions of the kinds of the contents recorded in advance in the storage medium of the portable terminal.

Further, in the above-described information processor, it is desirable that: a contents extracting condition storage unit which stores a past contents extracting condition used when extracting the contents recorded in the storage medium of the portable terminal be included in the storage medium of the portable terminal or the information processor; a contents extracting condition detecting unit for detecting the past contents extracting condition stored in the contents extracting condition storage unit be further included; viewed/listened state information indicating a viewed/listened state by a unit of contents recorded in the storage medium of the portable terminal be further recorded in the storage medium of the portable terminal; the kind detecting unit further detect the viewed/listened state information; and the contents extracting unit compare the viewed/listened state information detected by the kind detecting unit and the contents extracting condition detected by the contents extracting condition detecting unit and, based on a result of the comparison, change the kind detected by the kind detecting unit and, based on the changed kind, extract contents from a plurality of kinds of contents stored in the contents storage unit.

Further, in the above-described contents recording method, it is desirable that: a contents extracting condition storage unit which stores a past contents extracting condition used when extracting the contents recorded in the storage medium of the portable terminal be included in the storage medium of the portable terminal or the information processor; a contents extracting condition detecting step for detecting the past contents extracting condition stored in the contents extracting condition storage unit be further included; viewed/listened state information indicating a viewed/listened state by a unit of contents recorded in the storage medium of the portable terminal be further recorded in the storage medium of the portable terminal; the kind detecting step further detect the viewed/listened state information; and the contents extracting step compare the viewed/listened state information detected in the kind detecting step and the contents extracting condition detected in the contents extracting condition detecting step and, based on a result of the comparison, changes the kind detected in the kind detecting step and, based on the changed kind, extracts contents from a plurality of kinds of contents stored in the contents storage unit.

In the above-described present invention, the contents to be recorded to the storage medium of the portable terminal are changed according to the actual viewed/listened state. Thus, it is more likely that the contents of the user's preference are recorded to the storage medium of the portable terminal.

Further, the information processor of the present invention is an information processor for recording a part of a plurality of kinds of contents being stored in a contents storage unit to a storage medium of a portable terminal, which comprises: a deleting condition storage unit for storing a contents deleting condition set by a user; a contents deleting unit for deleting contents from contents recorded in advance in the storage medium of the portable terminal according to the contents deleting condition stored in the deleting condition storage unit; and a contents recording unit for recording a part of a plurality of kinds of contents stored in the contents storage unit to the storage medium of the portable terminal where contents are deleted by the contents deleting unit.

Also, the contents recording method of the present invention is a contents recording method performed by an information processor for recording a part of a plurality of kinds of contents being stored in a contents storage unit to a storage medium of a portable terminal, the method comprising: a deleting condition storing step for storing a contents deleting condition set by a user to the deleting condition storage unit; a contents deleting step for deleting contents from contents recorded in advance in the storage medium of the portable terminal according to the contents deleting condition stored in the deleting condition storage unit; and a contents recording step for recording a part of a plurality of kinds of contents stored in the contents storage unit to the storage medium of the portable terminal where contents are deleted in the contents deleting step.

In the above-described present invention, contents are selectively deleted from the contents recorded in advance in the storage medium of the portable terminal according to the contents deleting condition, and a part of a plurality of kinds of contents stored in the contents storage unit is recorded to the storage medium of the portable terminal where the contents are selectively deleted. Therefore, when recording new contents to the storage medium of the portable terminal, it enables to comply with the particular demand of the user for storing the contents, which is to record the new contents while keeping the contents which the user desires to keep in the storage medium of the portable terminal among the contents which have already been recorded in the storage medium of the portable terminal.

Further, it is desirable that the contents deleting condition be life of contents, number of days past from a recorded date of contents, or a contents exchange rate.

Further, in the above-described information processor, it is desirable that the contents recording unit comprise: an extracting condition storage unit for storing a contents extracting condition which indicates amount of the contents to be recorded to the storage medium and respective proportions of a plurality of kinds of contents with respect to an entire contents of a plurality of kinds to be recorded to the storage medium of the portable terminal; a contents extracting unit for extracting contents from a plurality of kinds of contents stored in the contents storage unit by satisfying the contents extracting condition stored in the extracting condition storage unit; and a recording unit for recording the contents extracted by the contents extracting unit to the storage medium of the portable terminal.

Also, in the above-described contents recording method, it is desirable that the contents recording step comprise: an extracting condition storing step for storing, to the extracting condition storage unit, a contents extracting condition being set by a user, which indicates amount of contents to be recorded to the storage medium and respective proportions of a plurality of kinds of contents; a contents extracting step for extracting contents from a plurality of kinds of contents stored in the contents storage unit by satisfying the contents extracting condition stored in the extracting condition storage unit; and a recording step for recording the contents extracted in the contents extracting step to the storage medium of the portable terminal.

With the above-described present invention, in addition to the above-described effects, it becomes possible to comply with the particular demand of the user for storing the contents, which is to set the proportion of the contents to be recorded to the storage medium of the portable terminal by each kind.

Further, in the above-described information processor, it is desirable that the contents recording unit comprise: an environment obtaining unit for obtaining environmental information indicating a surrounding environment; a contents extracting unit for extracting contents from a plurality of kinds of contents stored in the contents storage unit according to the environmental information obtained by the environment obtaining unit; and a recording unit for recording the contents extracted by the contents extracting unit to the storage medium of the portable terminal.

Further, in the above-described contents recording method, it is desirable that the contents recording step comprise: an environment obtaining step for obtaining environmental information indicating a surrounding environment; a contents extracting step for extracting contents from a plurality of kinds of contents stored in the contents storage unit according to the environmental information obtained in the environment obtaining step; and a recording step for recording the contents extracted in the contents extracting step to the storage medium of the portable terminal.

With the above-described present invention, in addition to the above-described effects, it becomes possible to comply with the particular demand of the user for storing the contents, which is to change the contents to be recorded to the storage medium of the portable terminal according to the change in the surrounding environment.

Further, in the above-described information processor, it is desirable that the contents recording unit comprise: a kind detecting unit for detecting kinds of contents which are recorded in advance in the storage medium of the portable terminal; a contents extracting unit for extracting contents from a plurality of kinds of contents stored in the contents storage unit according to the kinds detected by the kind detecting unit; and a recording unit for recording the contents extracted by the contents extracting unit to the storage medium of the portable terminal.

Also, in the contents recording method, it is desirable that the contents recording step comprise: a kind detecting step for detecting kinds of contents which are recorded in advance in the storage medium of the portable terminal; a contents extracting step for extracting contents from a plurality of kinds of contents stored in the contents storage unit according to the kinds detected in the kind detecting step; and a recording step for recording the contents extracted in the contents extracting step to the storage medium of the portable terminal.

With the above-described present invention, in addition to the above-described effects, for example, it enable to comply with the particular demand of the user for storing the contents, which is to change the contents to be recorded to the storage medium of the portable terminal while keeping the proportions of the kinds of the contents recorded in advance in the storage medium of the portable terminal.

Further, the program of the present invention is a program for a computer to execute contents recording processing for recording a part of a plurality of kinds of contents stored in a contents storage unit to a storage medium of a portable terminal by a recording unit, wherein the contents recording processing includes: extracting condition storing processing for storing, to an extracting condition storage unit, a contents extracting condition being set by a user, which indicates amount of contents to be recorded to the storage medium and respective proportions of a plurality of kinds of contents; contents extracting processing for extracting contents from a plurality of kinds of contents stored in the contents storage unit by satisfying the contents extracting condition stored in the extracting condition storage unit; and a recording processing for recording, by the recording unit, the contents extracted by the contents extracting processing to the storage medium of the portable terminal.

Further, the program of the present invention is a program for a computer to execute contents recording processing for recording a part of a plurality of kinds of contents stored in a contents storage unit to a storage medium of a portable terminal by a recording unit, wherein the contents recording processing includes: environment obtaining processing for obtaining, by the environment obtaining unit, environmental information indicating a surrounding environment; contents extracting processing for extracting contents from a plurality of kinds of contents stored in the contents storage unit according to the environmental information obtained by the environment obtaining processing; and recording processing for recording, by the recording unit, the contents extracted by the contents extracting processing to the storage medium of the portable terminal.

The program of the present invention is a program for a computer to execute contents recording processing for recording a part of a plurality of kinds of contents stored in a contents storage unit to a storage medium of a portable terminal by a recording unit, wherein the contents recording processing includes: kind detecting processing for detecting kinds of contents which are recorded in advance in the storage medium of the portable terminal; contents extracting processing for extracting contents from a plurality of kinds of contents stored in the contents storage unit according to the kinds detected by the kind detecting unit; and recording processing for recording, by the recording unit, the contents extracted by the contents extracting processing to the storage medium of the portable terminal.

Furthermore, the program of the present invention is a program for a computer to execute contents recording processing for recording a part of a plurality of kinds of contents stored in a contents storage unit to a storage medium of a portable terminal by a recording unit, wherein the contents recording processing includes: deleting condition storing processing for storing a contents deleting condition set by a user to the deleting condition storage unit; contents deleting processing for deleting, by a deleting unit, contents from the contents recorded in advance in the storage medium of the portable terminal according to the contents deleting condition stored in the deleting condition storage unit; and contents recording processing for recording, by a recording unit, a part of a plurality of kinds of contents stored in the contents storage unit to the storage medium of the portable terminal where contents are deleted by the contents deleting processing.

Further, the storage medium of the present invention is a storage medium which can be read out by a computer to which the above-described programs are recorded.

With the present invention as described above, it becomes possible to execute the above-described contents recording method through the computer.

With the present invention, the contents as desired by the user can be recorded to the storage medium of the portable terminal, so that it becomes possible for the user to easily view or listen to the one's desired contents by using the portable terminal.

Further, for example, since the contents to be recorded to the storage medium of the portable terminal are selected according to the surrounding environments or the past viewed/listened state of the contents recorded to the storage medium of the portable terminal, the desired contents which are not intentionally selected by the user are to be recorded to the storage medium of the portable terminal when recording the contents to the storage medium of the portable terminal. Thus, the user can view or listen to the contents with an essence of surprise.

### BRIEF DESCRIPTION OF THE DRAWINGS

FIG. 1 is a block diagram for showing an information processor according to a first embodiment of the present invention;

FIG. 2 is an explanatory illustration for showing an example of information stored in a memory 2a;

FIG. 3 is an explanatory illustration for showing an example of information stored in a memory card 4;

FIG. 4 is an explanatory illustration for showing an example of information stored in the memory card 4;

FIG. 5 is an explanatory illustration for showing an example of a first contents segmenting condition;

FIG. 6 is an explanatory illustration for showing an example of a second contents segmenting condition;

FIG. 7 is a block diagram for showing an example of the information processor shown in FIG. 1;

FIG. 8 is an explanatory illustration for showing an example of information stored in a contents database 1d2;

FIG. 9 is an explanatory illustration for showing an example of a contents segmenting condition selecting screen;

FIG. 10 is an explanatory illustration for showing an example of a contents segmenting condition detail setting screen;

FIG. 11 is an explanatory illustration for showing an example of the contents segmenting condition detail setting screen;

FIG. 12 is an explanatory illustration for showing an example of a memory card exchanging condition selecting screen;

FIG. 13 is an explanatory illustration for showing an example of an execution timing setting screen;

FIG. 14 is an explanatory illustration for showing an example of an execution time setting screen;

FIG. 15 is a flowchart for describing the actions of the information processor;

FIG. 16 is an explanatory illustration for showing an example of information stored in a contents database 1e2;

FIG. 17 is an explanatory illustration for showing an example of information stored in the contents database 1e2; and

FIG. 18 is an explanatory illustration for describing an example of contents extraction.

### DESCRIPTION OF THE PREFERRED EMBODIMENTS

A first embodiment of the present invention will be described by referring to accompanying drawings hereinafter.

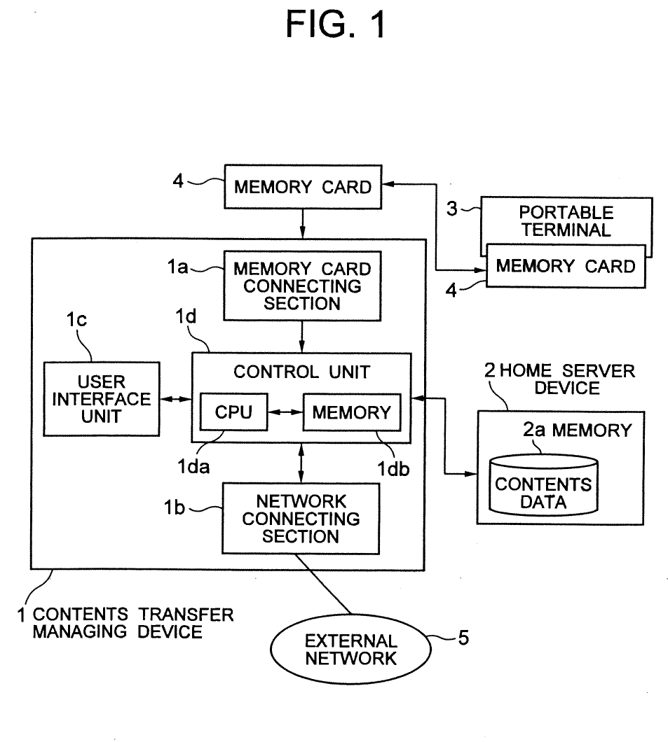

FIG. 1 is a block diagram for showing an information processor according to the first embodiment of the present invention.

In FIG. 1, a contents transfer managing device 1 as an information processor is a PC or an exclusive contents recording device, for example, which records a part of a plurality of kinds of contents stored in a home server device 2 as a contents storage unit onto a memory card 4 which functions as a storage medium of a portable terminal 3. The contents transfer managing device 1 comprises a memory card connecting section 1a, a network connecting section 1b, a user interface unit 1c, and a control unit 1d. The control unit 1d comprises a CPU 1da and a memory 1db.

The home server device 2 such as an HDD (Hard Disk Drive) recorder or a PC comprises a memory 2a as a storage medium which can be read out by the computer. The memory 2a stores a plurality of kinds of contents such as music, video, and the like and also information associated with each of a plurality of the contents.

In the embodiment, the memory 2a stores the contents by relating the contents to the contents name, the genre of the contents, the time (length) of the contents, and characteristic information (kinds) of the contents. In the embodiment, the title of the contents (contents name), the genre of the contents, the time (length) of the contents, and the characteristic information of the contents are the contents' related information.

For example, if music is the contents, the characteristic information of the contents shows the tempo of the music, the liveliness of the music, the bass state of the music, the number of times the music is listened to, sex of the singer, or the number of singers. Also, when a picture is the contents, it shows the degree of closeness between the user and the person in the picture or the brightness of the picture.

In the embodiment, the characteristic information of the contents is expressed numerically to be used. For example, when music is the contents, the liveliness of the music can be expressed numerically by extracting the tempo (Beats Per Minute).

Further, it is also possible to numerically express the extent of containing the bass sections (degree of bass) by checking a component of each frequency band through performing Fourier transformation. Also, by recording the number of times the contents (music) is listened to, it is possible to numerically express the contents (music) by the frequency of the listened times. Further, by numerically expressing the sex of the singer or the number of the singers, it becomes possible to classify the contents based on the sex of the singer or the number of the singers.

Further, when the picture is the contents, by numerically inputting the degree of the closeness between the one in the picture and the user, it becomes possible to classify the contents based on the relation of closeness. Also, by checking the brightness of the picture through an image analysis and numerically expressing the checked brightness, it becomes possible to classify the picture based on the brightness.

The contents characteristic information is not limited to the ones described above but can be modified as appropriate.

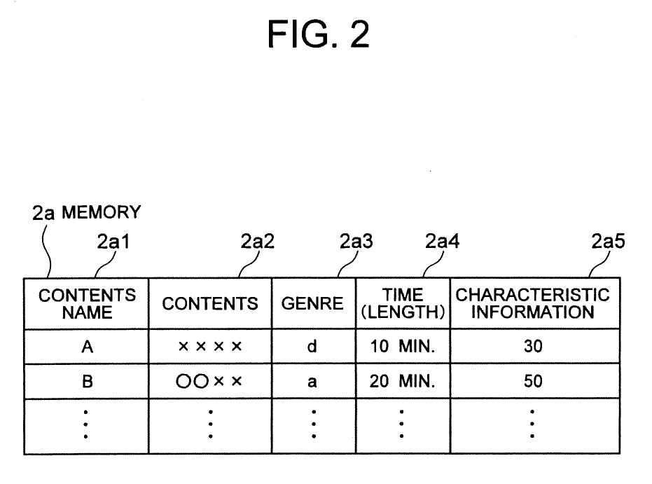

FIG. 2 is an explanatory illustration for showing an example of the information stored in the memory 2a. In FIG. 2, the memory 2a stores each of the contents by relating to contents name 2a1, a contents 2a2 specified by the contents name 2a1, a genre 2a3 of the contents 2a2, a time (length) 2a4 of the contents, and characteristic information 2a5 of the contents 2a2.

In the example shown in FIG. 2, for example, the contents name “A” 2a1, the contents “xxxx” 2a2 specified by the contents name “A,” the genre “d” 2a3 of the contents “xxxx” 2a2, the time (length) “ten minutes” 2a4 of the contents “xxxx” 2a2, and the characteristic information “30” 2a5 of the contents “xxxx” 2a2 are stored in the memory 2a by relating to each other.

The memory card 4 can be mounted/removed to/from the portable terminal 3. The portable terminal 3 can reproduce the contents recorded in the memory card 4 when the memory card 4 is being mounted. In the portable terminal 3, the number of reproducing the contents may be recorded to the memory card 4 when reproducing the contents recorded in the memory card 4.

The memory card 4 is a storage medium which the contents can be read out from or written to by the contents transfer managing device 1 and the portable terminal 3. The contents are recorded to the memory card 4 by the contents transfer managing device 1.

The contents transfer managing device 1 records the life of the contents to the memory card 4 when recording the contents to the memory card 4. Further, the contents transfer managing device 1 records the date of recording the contents to the memory card 4 when recording the contents to the memory card 4. Also, the contents transfer managing device 1 apply the protection setting to the contents at the time of recording the contents to the memory cared 4 so as to prevent deletion of the contents to which the protection setting is applied. Further, the contents transfer managing device 1 records the contents segmenting condition used for extracting the contents to the memory card 4 at the time of recording the contents to the memory card 4. The contents transfer managing device 1 (specifically, the CPU 1da) also records the contents segmenting condition used for extracting the contents to the memory 1db at the time of recording the contents to the memory card 4.

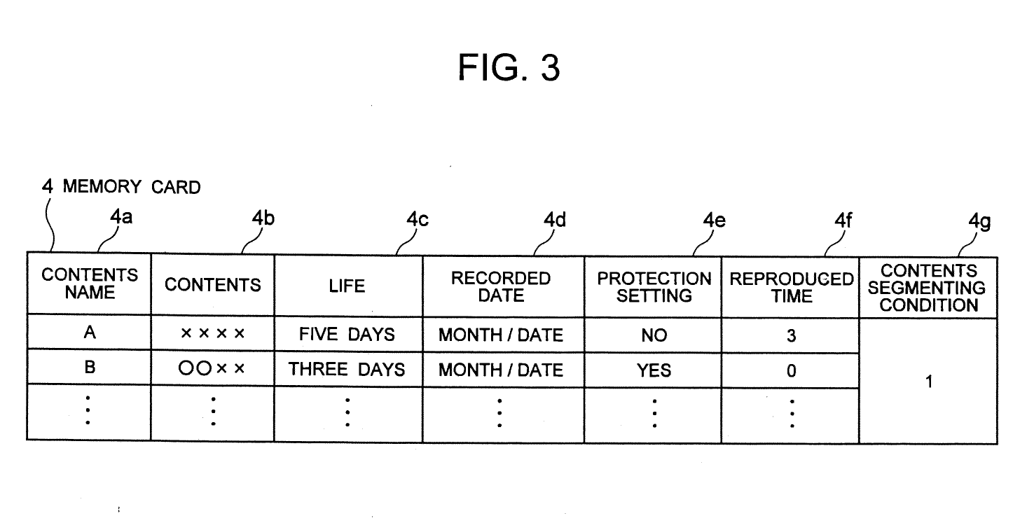

FIG. 3 is an explanatory illustration for showing an example of the information recorded to the memory card 4. In FIG. 3, the memory card 4 stores a contents name 4a, contents 4b specified by the contents name 4a, life 4c of the contents 4b, a recorded date 4d of the contents 4b, protection setting information 4e of the contents 4b, and reproduced time 4f of the contents 4b by relating to each other under each contents name. Further, the memory card 4 stores a contents segmenting condition 4g used for extracting the contents 4b.

In the example shown in FIG. 3, for example, the contents name “A” 4a, the contents “xxxx” 4b specified by the contents name “A,” life “five days” 4c of the contents “xxxx” 4b, the recorded date “month, date” 4d of the contents 4b, the protection setting information “NO” 4e of the contents “xxxx” 4b, and the reproduced time “3” 4f of the contents “xxxx” 4b are stored in the memory card 4 by relating to each other.

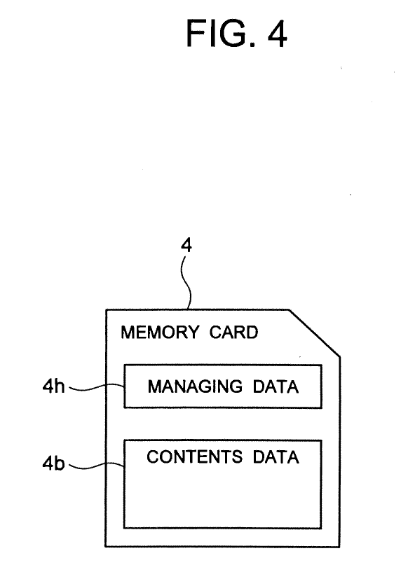

FIG. 4 is an illustration for showing an example of storing the information to the memory card 4. In FIG. 4, the contents name 4a, the life 4c, the recorded date 4d, the protection setting 4e, the reproduced time 4f, the contents segmenting condition 4g are collectively shown as a managing data 4h.

Recording to the memory card 4 performed by the contents transfer managing device 1 can be executed through the memory card connecting section 1a.

The memory card connecting section 1a shown in FIG. 1 can hold the memory card 4 removably.

The memory card connecting section 1a, by a contents unit, reads out the information regarding the contents recorded to the memory card 4 which is mounted to the unit itself. The information regarding the contents read out by the memory card connecting section 1a includes, for example, the contents name, the life of the contents, the viewed/listened state of the contents (the reproduced time of the contents), date of recording the contents, protection setting information of the contents, and the contents segmenting condition.

The memory card connecting section 1a supplies to the control unit 1d the information regarding the contents which are read out from the memory card 4 by a unit of contents.

As memory card exchange considering information, the control unit 1d stores, to the memory 1db by a contents unit, the contents name, the viewed/listened state (reproduced time) of the contents, the life of the contents, the date of recording the contents, the protection setting information of the contents, which are supplied from the memory card connecting section 1a by a contents unit.

The network connecting section 1b connects to an external network (communication line) 5 such as the Internet. The network connecting section 1b obtains the surrounding environmental information from an external server through the external network 5.

For example, the network connecting section 1b obtains the surrounding environmental information (for example, weather information) from an e-mail received from an external sender through the external network 5 or from the contents obtained from the external server through the external network 5. The network connecting section 1b supplies the surrounding environmental information obtained through the external network 5 to the control unit 1d.

The user interface unit 1c, for example, comprises an operation unit and a display unit for receiving an input from the user and, further, performs output to the user.

For example, the user interface unit 1c receives a single or a plurality of contents segmenting conditions set by the user. The contents segmenting condition is an extracting condition for extracting the contents desired by the user from a plurality of kinds of contents stored in the memory 2a of the home server device 2.

For example, the user interface unit 1c receives a first, a second and a third contents segmenting conditions. However, the contents segmenting conditions received by the user interface unit 1c are not limited to the first, second and third contents segmenting conditions.

The first contents segmenting condition is a condition which is to change the contents in the memory card 4 to comply with the contents extracting condition which indicates the amount of the contents to be recorded to the memory card 4 and proportions of each of a plurality of kinds of the contents with respect to the entire contents of a plurality of kinds to be recorded anew to the memory card 4.

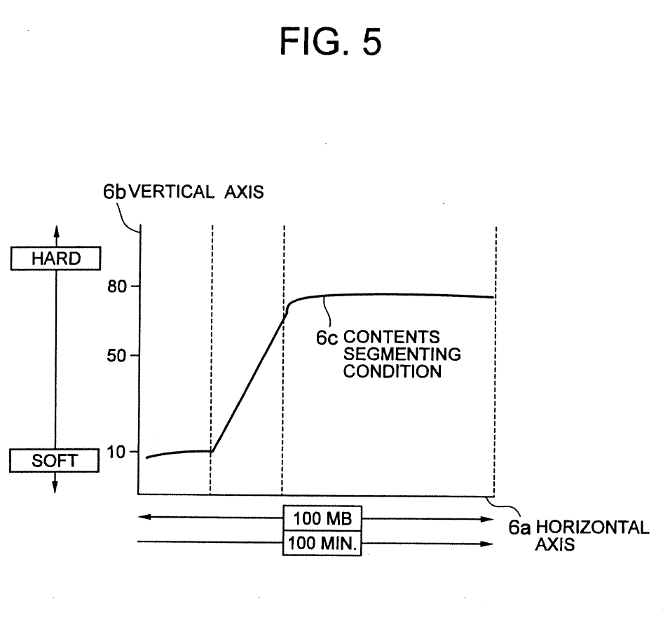

FIG. 5 is an explanatory illustration for showing an example of the contents extracting condition which indicates proportions of each of a plurality of kinds of the contents with respect to the entire contents of a plurality of kinds to be recorded anew to the memory card 4. In FIG. 5, a horizontal axis 6a represents the storage capacity (time) and a vertical axis 6b represents the characteristic (kinds) information (the degree of liveliness (tempo) of the music in the example shown in FIG. 5) of the contents. The contents extracting information 6c is received by the user interface unit 1c. The user selects the contents to be stored in the memory card 4 by setting the contents extracting condition 6c to meet the own preference through operating the user interface unit 1c.

The second contents segmenting condition is a condition which is to change the contents in the memory card according to the surrounding environment. The second contents segmenting condition is a condition which is to extract a soft music from the memory 2a as the weather goes bad and to extract gentle music as the temperature goes down when, for example, the weather information is used as the surrounding environmental information.

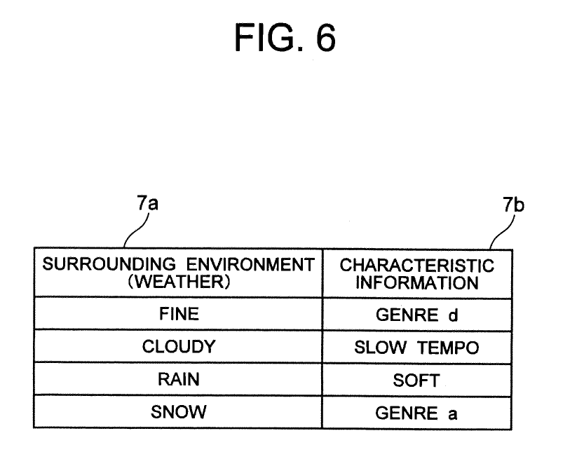

FIG. 6 is an explanatory illustration for showing an example of a condition which is to change the contents according to the surrounding environment. In FIG. 6, a surrounding environment (weather) 7a and the characteristic (kinds) information 7b of the contents are related. The user sets the relation between the surrounding environment 7a and the contents characteristic information 7b to meet the own preference through operating the user interface unit 1c so as to select the contents to be stored in the memory card 4. The surrounding environment 7a is not limited to the weather but may be the temperatures, for example.

The third contents segmenting condition is a condition which is to reuse the contents segmenting condition recorded in the memory card 4 as the contents segmenting condition.

The user interface unit 1c supplies the received contents segmenting condition to the control unit 1d. The control unit 1d stores the contents segmenting condition supplied from the user interface unit 1c to the memory 1db.

Further, the user interface unit 1c receives the contents segmenting condition selecting information which indicates to select the contents segmenting condition to be actually used from a plurality of contents segmenting conditions.

The control unit 1d extracts the contents from the memory 2a using the contents segmenting condition which is specified by the contents segmenting condition selecting information supplied from the user interface unit 1c, and executes the recording processing for recording the extracted contents to the memory card 4 through the memory card connecting section 1a.

Further, the user interface unit 1c receives a single or a plurality of memory card exchanging conditions set by the user. The memory card exchanging condition is a deletion condition which is for determining the contents to be deleted from the contents which are recorded in the memory card 4 when the memory card 4 is mounted to the contents transfer managing device 1.

For example, the user interface unit 1c receives a first, a second and a third memory card exchanging conditions. However, the memory card exchanging conditions received by the user interface unit 1c are not limited to the first, second and third memory card exchanging conditions.

The first memory card exchanging condition is a condition which is to delete the contents which has not been viewed/listened for a prescribed number of days or more from the memory card 4.

The second memory card exchanging condition is a condition which is to delete the contents with expired validation date (life) from the memory card 4. In this case, the contents transfer managing device 1 records the validation term (life) of the contents to the memory card 4 when recording the contents to the memory card 4.

The third memory card exchanging condition is a condition which is to delete the contents with an old recorded date from the memory card until achieving an exchange rate set by the user.

The user interface unit 1c supplies the received memory card exchanging condition to the control unit 1d. The control unit 1d stores the memory card exchanging condition supplied from the user interface unit 1c to the memory 1db.

Further, the user interface unit 1c receives the memory card exchanging condition selecting information which indicates to select the memory card exchanging condition to be actually used from a plurality of memory card exchanging conditions.

The control unit 1d, through the memory card connecting section 1a, executes the deleting processing for deleting the contents from the memory card 4 according to the memory card exchanging condition which is specified by the memory card exchanging condition selecting information supplied from the user interface unit 1c.

Further, the user interface unit 1c receives a single or a plurality of execution timing conditions set by the user.

For example, the user interface unit 1c receives a first, a second and a third execution timing conditions. However, the execution timing conditions received by the user interface unit 1c are not limited to the first, second and third execution timing conditions but may be modified as appropriate.

The first execution timing condition is “executed immediately.” The second execution timing condition is “executed at designated time (for example, “at fixed time everyday,” “at fixed time every week,” or “at fixed time on a specific day.” The third execution timing condition is “executed upon insertion of memory card.”

The user interface unit 1c supplies the received execution timing condition to the control unit 1d. The control unit 1d stores the execution timing condition supplied from the user interface unit 1c to the memory 1db.

Further, the interface unit 1c receives executing timing condition selecting information which indicates to select the execution timing condition to be actually used from a plurality of the execution timing conditions.

The control unit 1d, through the memory card connecting section 1a, executes the deleting processing of the contents and recording processing of the contents at a timing based on the execution timing condition which is specified by the execution timing condition selecting information supplied from the user interface unit 1c.

The control unit 1d comprises the CPU 1da as a computer and the memory 1db as a storage medium which can be read out by the computer. A program and various kinds of information for defining the action of the contents transfer managing device 1 are recorded in the memory 1db. The CPU 1da executes various functions by reading the program recorded in the memory 1db and executing the read program. In the followings, the functions executed by the CPU 1da will be described as the functions executed by the control unit 1d.

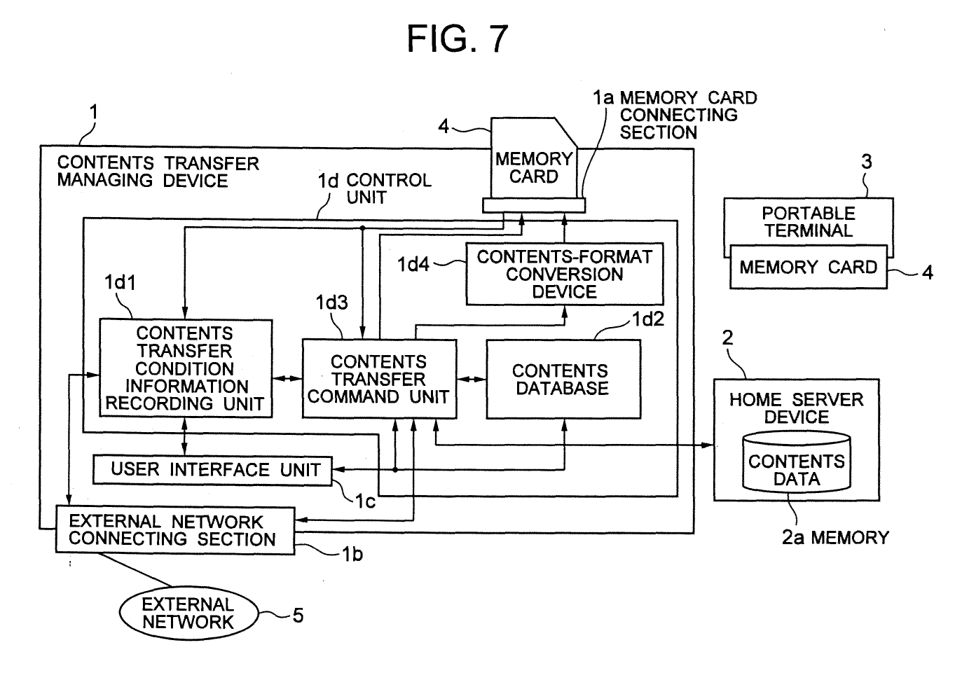

FIG. 7 is a functional block diagram for showing an example of the functions executed by the control unit 1d. In FIG. 7, the same reference numerals are applied to the components with the same configuration as those in FIG. 1. In FIG. 7, the control unit 1d comprises a contents transfer condition information recording unit 1d1, a contents database 1d2, a contents transfer command unit 1d3, and a contents-format conversion device 1d4. The contents transfer condition information recording unit 1d1 and the contents database 1d2 correspond to the memory 1db, while the contents transfer command unit 1d3 and the contents-format conversion device 1d4 correspond to the CPU 1da and the memory 1db.

The contents transfer condition information recording unit 1d1 stores the contents segmenting condition, the memory card exchanging condition, and the execution timing condition.

The contents database 1d2 stores the respective contents name, the genre, the time (length), and the characteristic information of a plurality of the contents stored in the memory 2a, which are read out from the memory 2a of the home server device 2 by the contents transfer command unit 1d3.

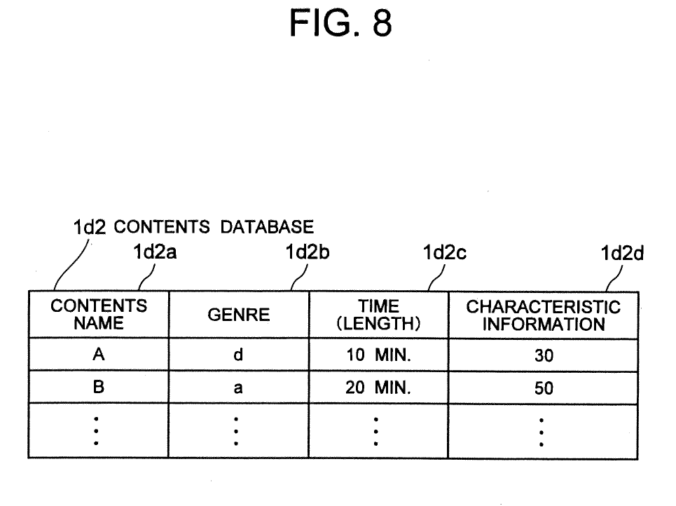

FIG. 8 is an explanatory illustration for showing an example of the information stored in the contents database 1d2. In FIG. 8, the contents database 1d2 stores the contents name 1d2a, the genre 1d2b of the contents specified by the contents name 1d2a, the time (length) 1d2c of the contents, and the contents characteristic information 1d2d by relating to each other under each contents name.

In the example shown in FIG. 8, for example, the contents name “A” 1d2a, the genre “d” 1d2b of the contents specified by the contents name “A,” the time (length) “10 minutes” 1d2c of the contents, and the characteristic information “30” 1d2d of the contents are stored in the contents database 1d2 by relating to each other.

The contents transfer command unit 1d3, through the memory card connecting section 1a, executes the deletion of the contents recorded in the memory card 4 and recording of the contents to the memory card 4.

For example, the contents transfer command unit 1d3 receives memory card exchange considering information (the contents name, the viewed/listened state of the contents (reproduced time of the contents), the life of the contents, the recorded date of the contents, the protection setting information of the contents, which are recorded by a unit of contents in the memory card 4), which is supplied from the memory card connecting section 1a.

Further, the contents transfer command unit 1d3 reads out the memory card exchanging condition specified by the memory card exchanging condition selecting information supplied from the user interface unit 1c from the contents transfer condition information recording unit 1d1.

The contents transfer command unit 1d3 detects the contents within the memory card 4, which satisfies the read-out memory card exchanging condition by referring to the memory card exchange considering information.

The contents transfer command unit 1d3, through the memory card connecting section 1a, executes the deleting processing for deleting the detected contents from the memory card 4 being mounted to the memory card connecting section 1a.

Further, the contents transfer command unit 1d3 reads out, from the contents transfer condition information recording unit 1d1, the contents segmenting condition specified by the contents segmenting condition selecting information which is supplied from the user interface unit 1c.

The contents transfer command unit 1d3 detects the contents within the memory 2a, which satisfies the read-out contents segmenting condition by referring to the information stored in the contents database 1d2.

The contents transfer command unit 1d3 reads out the detected contents from the memory 2a, and executes, through the memory card connecting section 1a, the recording processing for recording the read-out contents to the memory card 4 which is mounted to the memory card connecting section 1a.

The contents transfer command unit 1d3, through the memory card connecting section 1a, executes the deleting processing of the contents and the recording processing of the contents at the timing according to the execution timing condition which is specified by the execution timing condition selecting information supplied from the user interface unit 1c.

Further, the contents transfer command unit 1d3 comprises a clock unit (not shown) for keeping the time including dates (year, month, date).

The contents-format conversion device 1d4 converts the format of the contents supplied from the contents transfer command unit 1d3. For example, the contents-format conversion device 1d4 recompresses the contents supplied from the contents transfer command unit 1d3.

Next, the action will be described.

First, described is the action of storing up the contents (action for building the contents library) in the memory 2a of the home server device 2.

The home server device 2 stores the music contents to the memory 2a ripped from a music CD or by downloading it from the Internet and the like through a communication line, which are carried out by an operation of the user. Further, the home server device 2 stores, to the memory 2a, the video contents such as a TV program and the like, which are recorded by a video recording device such as an HDD recorder or the like.

As shown in FIG. 2, the home server device 2 stores the contents and the contents related information to the memory 2a by relating to each other by a unit of contents. The contents related information is not limited to the ones shown in FIG. 2 but may be modified as appropriate.

For example, when music is the contents, the home server device 2 may store, to the memory 2a, the name of the artist (name of the singer), the title of the album, the genre, the length (time), the tempo, the volume, the result of spectrum analysis, and also sensuous additional information such as “hard, soft, happy, sad” as the contents related information.

Further, when the video is the contents, the home server device 2 may store, to the memory 2a, the title of the program, the broadcasting station, the recording time (length), the recorded time zone, the genre, and also the additional information such as “bright, dark,” which is determined from the brightness of the screen as the contents related information.

Next, described is the action which is performed when the contents transfer managing device 1 is connected to the home server device 2.

When the contents transfer managing device 1 is connected to the home server device 2 and the user interface unit 1c receives a command from the user for executing the program recorded in the memory 1db by the CPU 1da, the contents transfer command unit 1d3 reads in the contents related information stored in the memory 2a of the home server device 2 and stores the read-in contents related information to the contents database 1d2.

When there are a plurality of folders in the memory 2a and the contents and the contents related information are stored in one of a plurality of the folders, the contents transfer command unit 1d3, when the user interface 1c receives a command from the user for designating the folder to which the contents and the contents related information are stored, reads in the contents related information stored in the folder which is designated by a command and stores the read-in contents related information to the contents database 1d2.

Further, if there is no additional information in the contents related information read out from the memory 2a, the contents transfer command unit 1d3 automatically creates additional information based on the read-out information and stores the created additional information to the contents database 1d2.

Furthermore, there may be a plurality of home server devices 2. Information regarding which home server device contains which contents is stored in the contents database 1d2.

By registering the folder to which the contents and the contents related information are stored in the program recorded in the memory 1db and having the program always being present, the related information of new contents may be automatically registered by the contents transfer command unit 1d3 to the contents database 1d2 when the new contents are stored in the memory 2a.

Next, described is an action performed when the memory card 4 is mounted to the contents transfer managing device 1.

When the memory card 4 which can be used in the portable terminal 3 is mounted to the contents transfer managing device 1 for the first time, the contents transfer command unit 1d3, through the memory card connecting section 1a, executes the folder forming processing for automatically forming the folder which stores the contents managing data (the name of the contents, the life, the date of recording, the protection setting, the reproduced number, and the contents segmenting condition) into the memory card 4.

Further, the contents transfer command unit 1d3, through the memory card connecting section 1a, checks the vacant capacity of the memory card 4 and displays the checked vacant capacity in the user interface unit 1c. The user recognizes the vacant capacity of the memory card 4 by viewing the display on the user interface unit 1c.

Next, described is an action of setting the contents segmenting condition.

When the user interface unit 1c receives a contents segmenting condition setting start command inputted by the user, the contents transfer command unit 1d3 displays a contents segmenting condition selecting screen in the display unit of the user interface unit 1c for encouraging to select the contents segmenting condition.

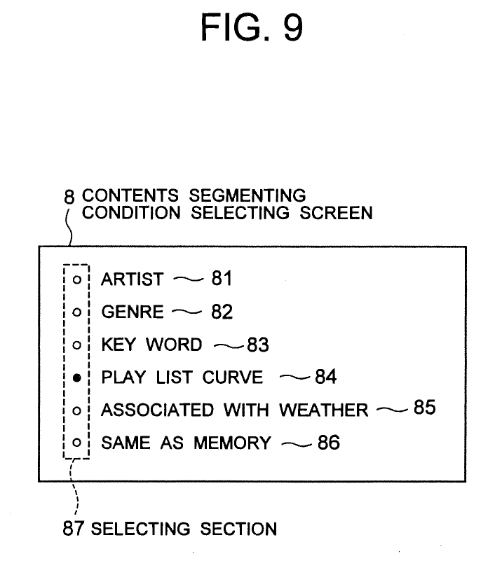

FIG. 9 is an explanatory illustration for showing an example of a contents segmenting condition selecting screen 8. The contents segmenting condition selecting screen 8 shown in FIG. 9 includes, as the contents segmenting conditions, “artist” 81, “genre” 82, “keyword” 83, play list curb” 84, “associated with weather” 85, and “same as the memory” 86.

When the “artist” 81, the “genre” 82, or the “keyword” 83 is selected, the contents transfer command unit 1d3 obtains the information which corresponds to the “artist” 81, the “genre” 82, or the “keyword” 83 being selected by referring to the additional information and the like within the contents related information in the contents database 1d2, and displays the obtained information on the user interface unit 1c.

For example, the user may create a play list curve in which the segmenting ratio for each artist is designated by selecting a plurality of artists from the artists' name displayed on the user interface unit 1c when selecting the “artist” 81. The similar setting as that of the “artist” 81 can be set for the “genre” 82 and “keyword” 83.

The “play list curve” 84 corresponds to the first contents segmenting condition which is to change the contents within the memory card 4 by satisfying the contents extracting condition which indicates the respective proportion of a plurality of kinds of contents with respect to the entire contents of a plurality of kinds to be recorded to the memory card 4.

The “associated with weather” 85 corresponds to the second contents segmenting condition which is to change the contents within the memory card according to the surrounding environment.

The “same as the memory” 86 corresponds to the third contents segmenting condition which is to change the contents within the memory card while maintaining the proportion of the kinds of the contents recorded in the memory card 4.

The user selects one of the contents segmenting conditions by operating the user interface unit 1c. When the user inter face unit 1c receives the selection of the contents segmenting condition determined by the user, the contents transfer command unit 1d3 reverses the display of selecting section 87, which is arranged in accordance with the selected contents segmenting condition in the contents segmenting condition selecting screen 8 (in FIG. 9, the display of the selecting section 87 arranged in accordance with the “play list curve” 84 is reversed). In this state, when the user interface unit 1c receives an input for execution from the user, the contents transfer command unit 1d3 displays, on the display unit of the user interface unit 1c, a contents segmenting condition detail setting screen for encouraging the detailed setting of the contents segmenting condition, which corresponds to the inversely-displayed selecting section 87.

In the embodiment, a case of selecting the “play list curve” 84, a case of selecting the “associated with weather” 85, and a case of selecting the “same as the memory” 85 will be described.

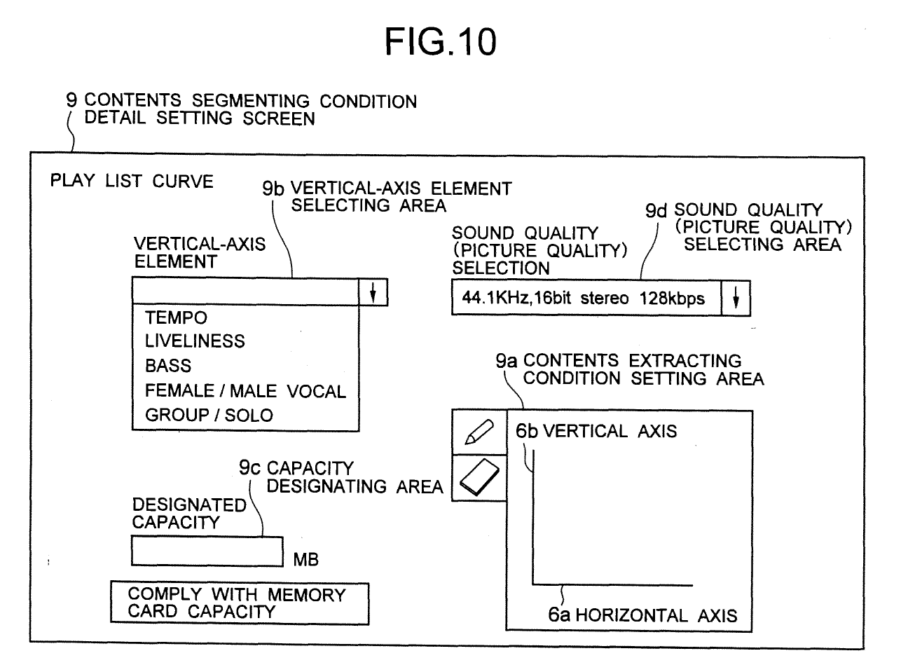

FIG. 10 is an explanatory illustration for showing an example of a contents segmenting condition detail setting screen 9 which is displayed when the “play list curve” 84 is selected.

In FIG. 10, the contents segmenting condition detail setting screen 9 includes a contents extracting condition setting area 9a, a vertical axis element selecting area 9b, a capacity designating area 9c, and sound quality (picture quality) selecting area 9d.

The contents extracting condition setting area 9a is an area where the contents extracting conditions indicating the respective proportion of a plurality of kinds of contents with respect to the entire contents of a plurality of kinds to be recorded anew to the memory card 4 is created by the user. FIG. 5 is an illustration for showing the state where the contents extracting condition is created in the contents extracting condition setting area 9a.

The vertical axis element selecting area 9b is an area where the user selects the vertical axis element (the kinds of the contents) within the contents extracting condition setting area 9a. The selection of the vertical axis elements correspond to the characteristic information 1d2d in the contents database 1d2. For example, when the tempo, liveliness, bass, female/male artists, and group/solo are set as the characteristic information 1d2d in the contents database 1d2, the selections of the vertical axis element may be the ones as shown in FIG. 10.

The capacity designating area 9c is an area where the user sets the capacity of the contents to be recorded anew to the memory card 4. The capacity of the contents to be recorded anew to the memory card 4 can be designated arbitrarily and may be obtained from the memory card 4.

The sound quality (picture quality) selecting area 9d is an area where the user sets the sound quality or the picture quality of the contents to be recorded to the memory card 4. By setting the sound quality or the picture quality in the sound quality (picture quality) selecting area 9d, the relation between the capacity of the contents (for example, the time of the contents) and the capacity of the memory card can be made clear. The contents-format conversion device 1d4 shown in FIG. 7 compresses the contents according to the sound quality (picture quality) set in the sound quality (picture quality) selecting area 9d.

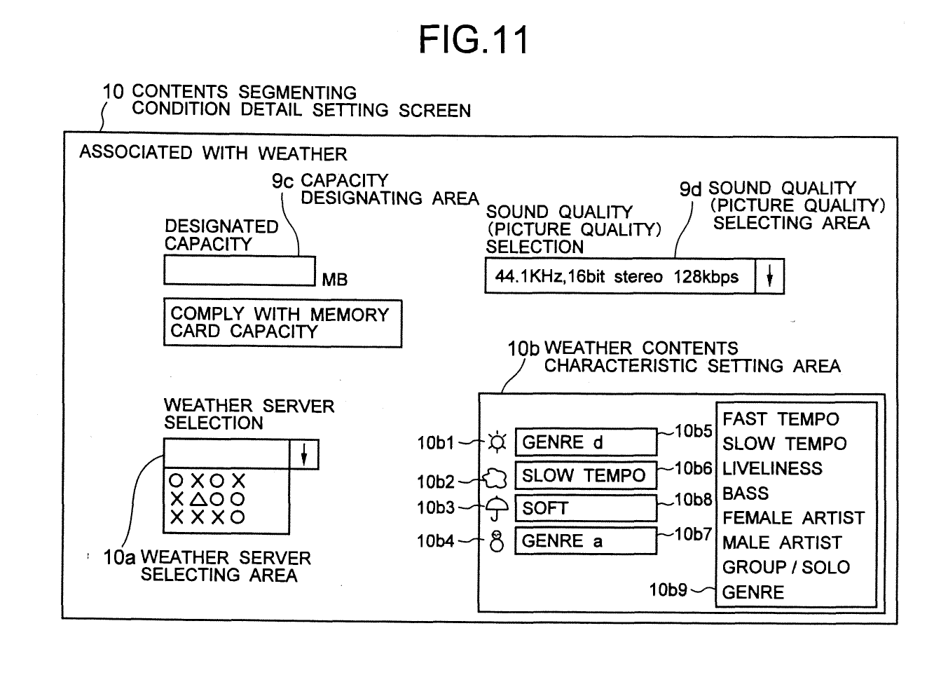

FIG. 11 is an explanatory illustration for showing an example of a contents segmenting condition detail setting screen 10, which is displayed when the “associated with weather” 85 is selected. In FIG. 11, the same reference numerals are applied to the same components as those shown in FIG. 10.

In FIG. 11, the contents segmenting condition detail setting screen 10 includes a weather server setting area 10a, a weather contents characteristic setting area 10b, a capacity designating area 9c, and a sound quality (picture quality) selecting area 9d.

The weather server setting area 10a is an area where the user selects the server which provides the weather information. The server providing the weather information is connected to the network connecting section 1b through the external network 5.

The weather contents characteristic setting area 10b includes a fine-weather contents condition setting unit 10b5 for setting the contents to be associated with fine-weather 10b1, a cloudy-weather contents condition setting unit 10b6 for setting the contents to be associated with cloudy-weather 10b12, a rain contents condition setting unit 10b7 for setting the contents to be associated with rain 10b3, a snow contents condition setting unit 10b8 for setting the contents to be associated with snow 10b4, and a contents condition display unit 10b9 for displaying the contents condition.

By operating the user interface unit 1c, the user arbitrarily allots the contents conditions displayed on the contents condition display unit 10b9 to the fine-weather contents condition setting unit 10b5, the cloudy-weather contents condition setting unit 10b6, the rain contents condition setting unit 10b7, and the snow contents condition setting unit 10b8.

In FIG. 9, when the “same as the memory” 86 is selected by the user, the contents transfer command unit 1d3 reuses, as the contents segmenting condition, the previously-used contents segmenting condition.

The contents segmenting condition used at the time of previous recording of the contents is recorded in the memory card 4 (see FIG. 3). Therefore, when the “same as the memory” 86 is selected, the contents transfer command unit 1d3 reads out and reuses the previous contents segmenting condition 4g recorded in the memory card 4.

The contents segmenting condition which is used for the previous contents recording is recorded in the memory 1db as well, so that the contents transfer command unit 1d3 may read out and reuse the previous contents segmenting condition 4g recorded in the memory 1db.

In this case, it is possible for the user to selectively use each of a plurality of memory cards (that is, to use the memory card in which the contents are changed according to the weather or the memory card to which a plurality of pieces of music are recorded in order from a slow tempo to a high tempo).

A common setting may be set for the segmentation (extraction) of the contents in each of the contents segmenting condition. For example, set as the common settings of the contents segmenting condition may be a setting which is not to record the contents to the memory card 4 which is recorded recently (within seven days, for example) to the memory card 4, a setting which is not to additionally record the contents to the memory card 4 which have already been recorded to the memory card 4, and a setting which is to preferably record the contents to the memory card 4 which has been recorded to the memory card 4 for the less number of times. In this case, the contents transfer command unit 1d3 extracts the contents according to the common setting.

Further, for example, when the number of contents stored in the memory 2a is small, there may be a case where extraction of the contents from the memory 2a in accordance with the contents segmenting condition becomes difficult. In this case, the contents transfer command unit 1d3 provides a warning for indicating so by the user interface unit 1c, so that the contents which almost satisfy the contents segmenting condition may be extracted from the memory 2a.

Further, when it is difficult to extract the contents according to the contents segmenting condition from the memory 2a, the contents transfer command unit 1d3 may cancel the extraction of the contents from the memory 2a. When the exchange of the contents for the memory card 4 is automatically executed, the contents transfer command unit 1d3 writes the cancel of the contents extraction to the action history when the contents transfer command unit 1d3 cancels the extraction of the contents from the memory 2a.

Next, an action of setting the memory card exchanging condition will be described.

When the user interface unit 1c receives a starting command for setting memory card exchanging condition inputted by the user, the contents transfer command unit 1d3 displays a memory card exchanging condition selecting screen for encouraging to select the memory card exchanging condition on the display unit of the user interface unit 1c.

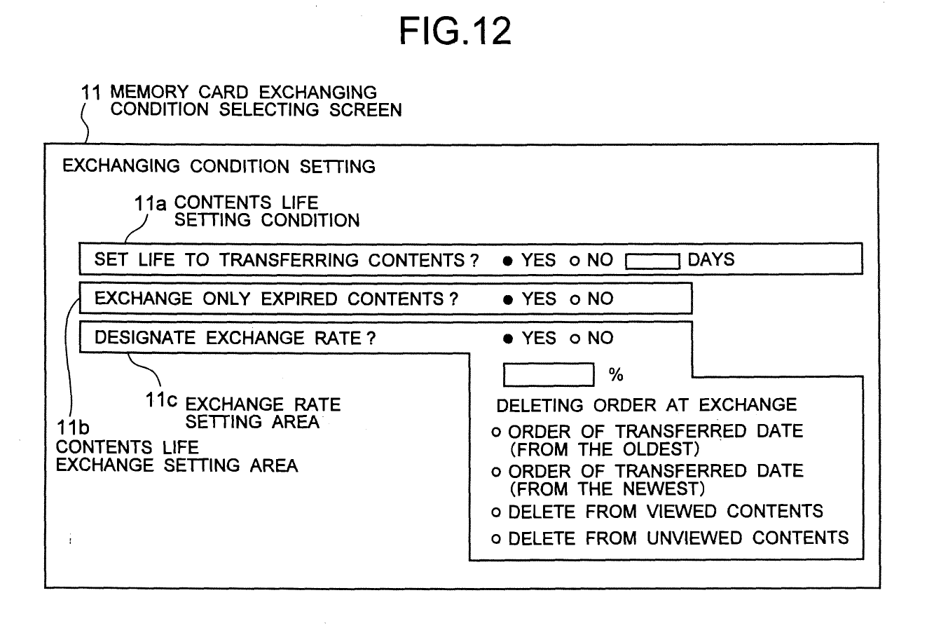

FIG. 12 is an explanatory illustration for showing an example of a memory card exchanging condition selecting screen 11. The memory card exchanging condition selecting screen 11 shown in FIG. 12 includes a contents life setting area 11a, a contents life exchange setting area 11b, and an exchange rate setting area 11c.

The contents life setting area 11a is an area where the user sets the life to each of the contents recorded in the memory card 4. When the memory card 4 containing the contents with the expired date is connected to the memory card connecting section 1c, the contents transfer command unit 1d3 automatically deletes the expired contents from the memory card 4.

The contents life exchange setting area 11b is an area where the user sets the memory card exchanging condition which is to automatically delete only the expired contents by the contents transfer command unit 1d3 when the memory card 4 containing the expired contents is connected to the memory card connecting section 1c.

The exchange rate setting area 11c is an area where the user sets the exchange rate of the contents which have already been recorded in the memory card 4. By setting the exchange rate in the exchange rate setting area 11c, it enables the user to designate the percentage of the contents to be exchanged but not to delete all the contents which have already been recorded in the memory card 4. Through the memory card exchanging condition selecting screen 11, it is possible to designate the order of deleting the contents according to the date of the contents (recorded date), or based on the state of viewed/unviewed.

Next, an action of setting the execution timing will be described.

When the user interface unit 1c receives a start command for setting the execution timing inputted by the user, the contents transfer command unit 1d3 displays the execution timing setting screen on the display unit of the user interface unit 1c for encouraging to set the execution timing.

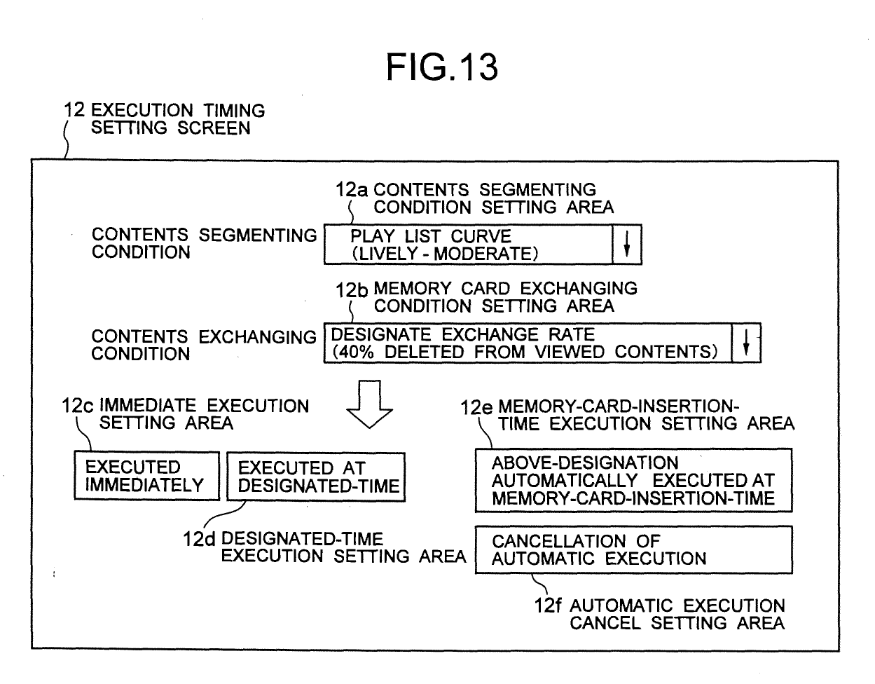

FIG. 13 is an explanatory illustration for showing an example of an execution timing setting screen 12. The execution timing setting screen 12 includes a contents segmenting condition setting area 12a, a memory card exchanging condition setting area 12b, an immediate execution setting area 12c, a designated-time execution setting area 12d, a memory-card-inserted-time execution setting area 12e, and an automatic execution cancel setting area 12f.

In the embodiment, as the execution timing, it is possible to set “executed immediately” (referred to as “A” hereinafter), “executed at a designated time” (for example, “at a fixed time everyday,” “at a fixed time every week,” or “at a fixed time on a specific day”) (referred to as “B” hereinafter), and “executed upon insertion of the memory card” (referred to as “C” hereinafter).

Specifically, when the user selects the immediate execution setting area 12c by operating the user interface unit 1c, “A” (executed immediately) is set as the execution timing. Further, when the user selects the designated-time execution setting area 12d by operating the user interface unit 1c, “B” (executed at the designated time) is set as the execution timing. Also, when the user selects the memory-card-inserted-time execution setting area 12e by operating the user interface unit 1c, “C” (executed at memory card insertion time) is set as the execution timing.

When the user selects the designated-time execution setting area 12d by operating the user interface unit 1c, the contents transfer command unit 1d3 displays the execution time setting screen on the display unit of the user interface unit 1c for encouraging to set the execution time.

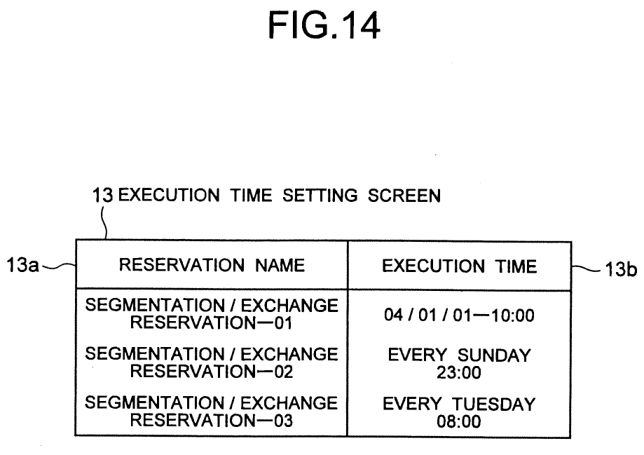

FIG. 14 is an explanatory illustration for showing an example of an execution time setting screen 13. The execution time setting screen 13 includes a reserved name section 13a and an execution time section 13b. The reserved name section 13a is an area where the user sets the reserved name of the execution time. The execution time section 13b is an area where the user sets the execution time.

Further, when the user sets “A” or “B,” the user operates the user interface unit 1c for designating in advance the contents segmenting condition and the memory card exchanging condition in the contents segmenting condition setting area 12a and in the memory card exchanging condition setting area 12b, respectively.

For example, the user names each of a plurality of contents segmenting conditions and memory card exchanging conditions, and the contents transfer condition information recording unit 1d1 stores each of a plurality of the contents segmenting conditions and the memory card exchanging conditions along with the respective names.

The user, by operating the user interface unit 1c, sets the contents segmenting condition selecting information which designates the desired contents segmenting condition (for example, the name of the desired contents segmenting condition) to the contents segmenting condition setting area 12a among a plurality of the contents segmenting conditions.

Further, the user, by operating the user interface unit 1c, sets the memory card exchanging condition selecting information which designates the desired memory card exchanging condition (for example, the name of the desired memory card exchanging condition) to memory card exchanging condition setting area 12b among a plurality of the memory card exchanging conditions.

As for a method for designating the action of “C,” performed first is a setting for designating whether or not the exchange action is automatically performed upon insertion of the memory card. And, under that setting, it is designated whether or not to perform the automatic exchange action at the time of inserting the memory card. Subsequently, designated is which of the contents segmenting condition or the memory card exchanging condition is used as the contents segmenting condition and the memory card exchanging condition at the time of exchanging. The designations are carried out using the contents segmenting condition selecting information and the memory card exchanging condition selecting information.

Further, when the user selects the automatic execution cancel setting area 12f by operating the user interface unit 1c, the contents transfer command unit 1d3 prohibits the exchange of the contents in the memory card 4 and records the contents segmenting condition and the memory card exchanging condition set by the execution timing setting screen 12 to the memory card 4.

The capacity designated by the contents segmenting condition is rewritten according to the memory card exchanging condition.

After completing the above-described settings, the contents transfer command unit 1d3, through the memory card connecting section 1a, executes the deleting processing of the contents and the recording processing of the contents at the timing according to the execution timing condition which is specified by the execution timing condition selecting information supplied from the user interface unit 1c.

As for the order of the actions, the exchange capacity is calculated from the memory card exchanging condition, and the exchange-target contents in the memory card 4 are deleted for keeping the capacity in the memory card 4.

Subsequently, the segmenting capacity is reflected onto the contents segmenting condition, and extraction of the contents and recording of the extracted contents to the memory card 4 are carried out.

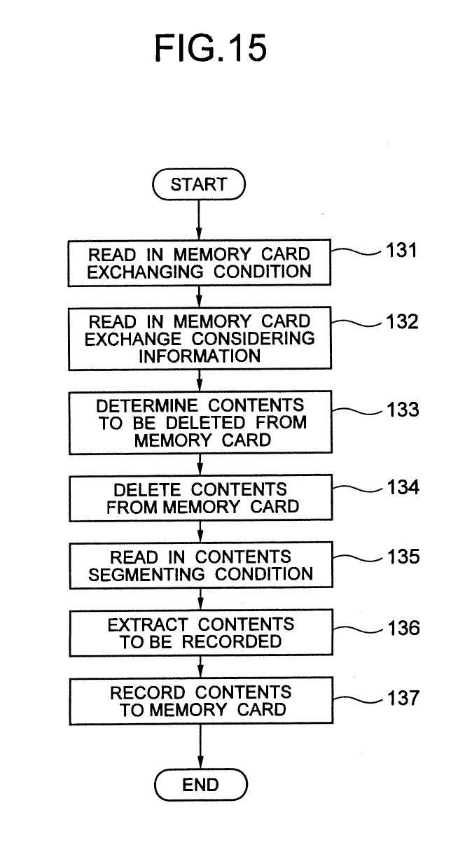

FIG. 15 is a flowchart for describing the contents deleting action and the contents recording action performed by the information processor 1 and, specifically, by the contents transfer command unit 1d3. In the followings, the actions of the information processor 1, specifically, the contents transfer command unit 1d3, will be described by referring to FIG. 15.

In the description provided in the followings, it is supposed that the second memory card exchanging condition (the condition which is to delete the expired contents from the memory card 4) is designated by the memory card exchanging condition selecting information and the first contents segmenting condition (the condition which is to change the contents within the memory card 4 by satisfying the contents extracting condition which indicates the respective proportions of a plurality of kinds of contents with respect to the entire contents of a plurality of kinds to be recorded to the memory card 4) is designated by the contents segmenting condition selecting information.

In a step 131, the contents transfer command unit 1d3 reads out the second memory card exchanging condition designated by the memory card exchanging condition selecting information from the contents transfer condition information recording unit 1d1.

Subsequently, in a step 132, the contents transfer command unit 1d3, through the memory card connecting section 1a, executes the processing for reading out, by a unit of contents, the information regarding the contents recorded in the memory card 4 being mounted to the memory card connecting section 1a. The contents transfer unit 1d3 receives the information regarding the contents, which is read out by the unit of contents by the memory card connecting section 1a as the memory card exchange considering information.

In the embodiment, the memory card connecting section 1a reads out, as the memory card exchange considering information, the contents name 4a, the contents recorded date 4d, the contents life 4c, and the viewed/listened state of the contents (the reproduced time of the contents) 4f among the information shown in FIG. 3.

Subsequently, in a step 133, the contents transfer command unit 1d3 detects the contents within the memory card 4, which satisfies the memory card exchanging condition read out in the step 131, by referring to the memory card exchange considering information (the contents name 4a, the contents life 4c, the contents recorded date 4d, and the viewed/listened state of the contents (the reproduced time of the contents) 4f), which is read out in the step 132.

For example, the contents transfer command unit 1d3 detects the contents in which the date obtained by adding the life of the contents 4c to the contents recorded date 4d becomes that of the past.

Subsequently, in a step 134, the contents transfer command unit 1d3 executes the deleting processing for deleting the contents detected in the step 133 from the memory card 4 by the memory card connecting section 1a.

Then, in a step 135, the contents transfer command unit 1d3 reads out the first contents segmenting condition from the contents transfer condition information recording unit 1d1.

Subsequently, in a step 136, the contents transfer command unit 1d3 extracts the contents within the memory 2a, which satisfies the contents segmenting condition read out in the step 135, by referring to the information stored in the contents database 1d2.

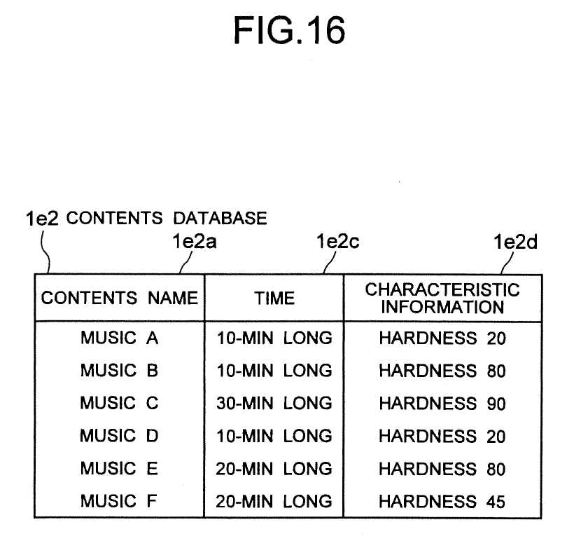

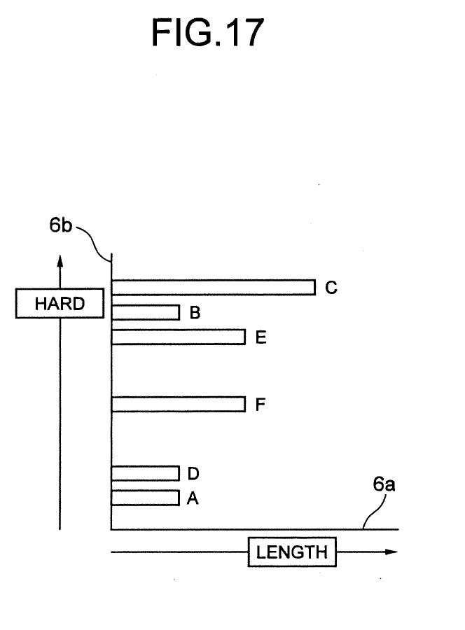

For example, when the contents database 1d2 stores the information as shown in FIG. 16, each piece of music specified by the respective contents name is classified by the extent of hardness (parameter of hardness) as the characteristic information as shown in FIG. 17.

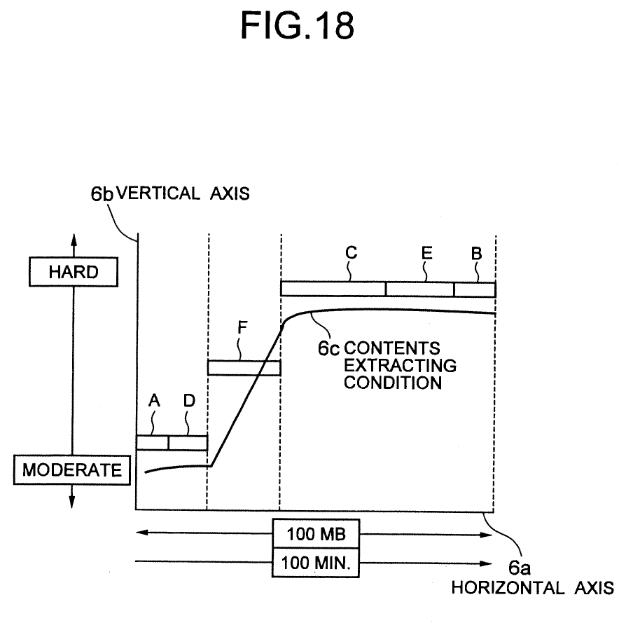

For example, the contents transfer command unit 1d3, as shown in FIG. 18, selects the contents from the memory 2a by satisfying the contents segmenting condition read out in the step 135.

Subsequently, in a step 137, the contents transfer command unit 1d3 executes the recording processing for recording the contents extracted in the step 136 to the memory card 4 by the contents connecting section 1a.

In the embodiment, the contents extracted from a plurality of kinds of contents stored in the memory 2a of the home server device 2 are recorded in the memory card 4 by satisfying the contents extracting condition which indicates the respective proportions of a plurality of kinds of contents with respect to the entire contents of a plurality of kinds to be recorded in the memory card 4. Therefore, it enables to comply with the particular demand of the user for storing the contents, which is to set the respective proportions of a plurality of kinds of the contents with respect to the entire contents of a plurality of kinds to be recorded in the memory card 4.

Further, the contents are selectively deleted from those contents recorded in the memory card 4 according to the memory card exchanging condition, and a part of a plurality of kinds of contents stored in the memory 2a of the home server device 2 is recorded to the memory card from which the contents are selectively deleted. Thus, when new contents are to be recorded to the memory card 4, the new contents can be recorded while keeping the contents which the user prefers to keep recorded in the memory card 4 among the contents which have already been recorded in the memory card 4.

Therefore, it becomes possible to satisfy the particular demand of the user for storing the contents, which is to record the new contents while keeping the contents which the user prefers to keep recorded in the memory card 4 among the contents which have already been recorded in the memory card 4.

In the above-described embodiment, the hardness (tempo) of the music is used as the contents characteristic information (the vertical axes in FIG. 5 and FIG. 10) to be used for the contents extracting condition. However, the contents characteristic information is not limited to the hardness (tempo) of the music but may be modified as appropriate.

For example, when the music is the contents, it may be set as the liveliness of the music, the bass of the music, the listened times of the music (reproduced times), the sex of the singer, or the number of the singers. When the picture is the contents, it may be set as the degree of the closeness between the person(s) in the pictures and the user, or the brightness of the picture. In this case, it is essential that the contents characteristic information used for the contents extracting condition is stored as the characteristic information 2a5 stored in the memory 2a.

Further, in the above-described embodiment, the first contents segmenting condition is used as the contents segmenting condition. However, the contents segmenting condition can be modified as appropriate.

For example, as the contents segmenting condition, the second segmenting condition, which is to change the condition in accordance with the surrounding environment, may be used. In this case, the user inputs the contents segmenting condition selecting information for designating the second contents segmenting condition to the contents transfer managing device 1 by operating the user interface unit 1c. Further, the contents transfer command unit 1d3 carries out the step 135 and the step 136 shown in FIG. 15 in the manner as described below.

In the step 135, the contents transfer command unit 1d3 reads out the second contents segmenting condition from the contents transfer condition information recording unit 1d1.

Subsequently, in the step 136, the contents transfer command unit 1d3 extracts the contents within the memory 2a, which satisfies the second contents segmenting condition read out in the step 135, according to the surrounding environmental information obtained by the external network connecting section 1b through the external network 5.

For example, the contents transfer command unit 1d3, when reading out the second contents segmenting condition in the step 135, connects the external network connecting section 1b to the weather server which is designated in the weather server setting area 10a shown in FIG. 11. Further, the contents transfer command unit 1d3, through the external network connecting section 1b, obtains the weather conditions, for example, the weather information as the surrounding environmental information, from the connected weather server.

The contents transfer command unit 1d3 reads out the contents characteristic information (see FIG. 6) stored in the contents transfer condition information recording unit 1d1 by relating to the weather information obtained from the weather server.

The contents transfer command unit 1d3 extracts the contents having the characteristic information complying with the read-out contents characteristic information by referring to the information stored in the contents database 1d2. Hereinafter, in a step 137, the contents transfer command unit 1d3 executes the recording processing for recording the contents extracted in the step 136 to the memory card 4 by the contents connecting section 1a.

When the second contents segmenting condition is used as the contents segmenting condition, the contents extracted from a plurality of kinds of contents stored in the memory 2a according to the surrounding environment are recorded in the memory card 4. Therefore, it enables to comply with the particular demand of the user for storing the contents, which is to change the contents to be recorded to the memory card 4 in accordance with the change in the surrounding environment.

Further, as the contents segmenting condition, the third condition, which is to reuse the contents segmenting condition recorded in the memory card 4, may be used. In this case, the user inputs the contents segmenting condition selecting information, which designates the third contents segmenting condition, to the contents transfer managing device 1 by operating the user interface unit 1c. Further, the contents transfer command unit 1d3 carries out the step 135 and the step 136 shown in FIG. 15 in the manner as described below.

In the step 135, the contents transfer command unit 1d3 reads out the third contents segmenting condition from the contents transfer condition information recording unit 1d1.

Subsequently, in the step 136, the contents transfer command unit 1d3 extracts the contents within the memory 2a, which satisfies the third contents segmenting condition read out in the step 135, according to the previous contents segmenting condition which is read out from the memory card 4 by the memory card connecting section 1a.

Hereinafter, in the step 137, the contents transfer command unit 1d3 executes the recording processing for recording the contents extracted in the step 136 to the memory card 4 by the contents connecting section 1a.

When the third contents segmenting condition is used as the contents segmenting condition, the contents which are extracted from a plurality of kinds of contents stored in the memory 2a according to the kinds of the contents recorded in advance in the memory card 4 are recorded to the memory card 4. Therefore, for example, it enables to comply with the particular demand of the user for storing the contents, which is to change the contents to be recorded to the memory card while keeping the proportions of the kinds of the contents being recorded in advance in the memory card 4. The kinds of the contents recorded in advance in the memory card 4 comply with the contents extracting condition used for extracting the contents recorded in advance in the memory card 4.

When the memory card 4 stores the viewed/listened state information showing the viewed/listened state (for example, whether or not it has been viewed/listened) for each set of the contents recorded in the memory card 4, the action may be carried out in the manner as described below.

The contents transfer command unit 1d3 detects the viewed/listened state information recorded in the memory card 4 through the contents connecting section 1a.

The contents transfer command unit 1d3 calculates the viewing/listening proportion by each kind of the contents recorded in the memory card 4 according to the viewed/listened state information detected by the contents connecting section 1a.

The contents transfer command unit 1d3 obtains the past contents extracting condition used for extracting the contents recorded in advance in the memory card 4 from the memory card 4 or the memory 1db.

The contents transfer command unit 1d3 compares the past contents extracting condition and the calculation result of the viewing/listening proportion by each kind of the contents recorded in the memory card 4.

The contents transfer command unit 1d3, based on the result of the comparison, creates the new third contents segmenting condition by altering the old contents extracting condition so that the proportion of the kinds of the contents actually being viewed/listened becomes large and the proportion of the contents which are not actually viewed/listened becomes small.

The contents transfer command unit 1d3 extracts the contents within the memory 2a, which satisfies the new third contents segmenting condition, according to the previous contents segmenting condition which is read out from the memory card 4 by the memory card connecting section 1a.

Hereinafter, in the step 137, the contents transfer command unit 1d3 executes the recording processing for recording the contents extracted in the step 136 to the memory card 4 through the contents connecting section 1a.

Further, in the above-described embodiment, the second memory card exchanging condition is used as the memory card exchanging condition. However, the memory card exchanging condition can be modified as appropriate.

For example, as the memory card exchanging condition, the first memory card exchanging condition, which is to delete the contents which have not been viewed/listened for prescribed days or more, may be used. In this case, the user inputs the memory card exchanging condition selecting information which designates the first memory card exchanging condition to the contents transfer managing device 1 by operating the user interface unit 1c. Further, the contents transfer command unit 1d3 carries out the step 131 and the step 133 shown in FIG. 15 in the manner as described below.

In the step 131, the contents transfer command unit 1d3 reads out the first memory card exchanging condition designated by the memory card exchanging condition selecting information from the contents transfer condition information recording unit 1d1.

Subsequently, in the step 133, the contents transfer command unit 1d3 detects the contents within the memory card 4, which satisfies the memory card exchanging condition read out in the step 131, by referring to the memory card exchange considering information (the contents name 4a, the contents life 4c, the contents recorded date 4d, and the viewed/listened state of the contents (the reproduced time of the contents) 4f), which is read out in the step 132. For example, the contents transfer command unit 1d3 detects the contents when the prescribed number of days past from a recorded date of the contents and also the contents reproduced time 4f is “0.”

Hereinafter, the contents transfer command unit 1d3 carries out the actions from the step 134 and thereafter.

Further, for example, as the memory card exchanging condition, the third memory card exchanging condition, which is to delete the contents with the old recorded date from the memory card 4 until reaching the exchange rate set by the user, may be used. In this case, the user inputs the memory card exchanging condition selecting information which designates the third memory card exchanging condition to the contents transfer managing device 1 by operating the user interface unit 1c. Further, the contents transfer command unit 1d3 carries out the step 131 and the step 133 shown in FIG. 15 in the manner as described below.

In the step 131, the contents transfer command unit 1d3 reads out the third memory card exchanging condition designated by the memory card exchanging condition selecting information from the contents transfer condition information recording unit 1d1.

Subsequently, in the step 133, the contents transfer command unit 1d3 detects the contents within the memory card 4, which satisfies the memory card exchanging condition read out in the step 131, by referring to the memory card exchange considering information (the contents name 4a, the contents life 4c, the contents recorded date 4d, and the viewed/listened state of the contents (the reproduced time of the contents) 4f), which is read out in the step 132.

For example, the contents transfer command unit 1d3 detects the old contents in the order of the contents recorded date 4d until reaching the exchange rate which is set by the user. Hereinafter, the contents transfer command unit 1d3 carries out the actions from the step 134 and thereafter.

In the embodiments described above, the configurations shown in the drawings are presented as mere examples, and the present invention is not to be limited to those configurations.

What is claimed is:

1. An information processor for recording a part of a plurality of kinds of contents being stored in a contents storage unit to a storage medium of a portable terminal, the information processor comprising:
an environment obtaining unit for obtaining environmental information indicating a surrounding environment;
a contents extracting unit for extracting contents from a plurality of kinds of contents stored in the contents storage unit according to the environmental information obtained by the environment obtaining unit; and
a recording unit for recording the contents extracted by the contents extracting unit to the storage medium of the portable terminal.

2. The information processor according to claim 1, wherein
the environment obtaining unit obtains weather information as the environmental information.

3. A contents recording method performed by an information processor which records a part of a plurality of kinds of contents being stored in a contents storage unit to a storage medium of a portable terminal, the method comprising:
an environment obtaining step for obtaining environmental information indicating a surrounding environment;
a contents extracting step for extracting contents from a plurality of kinds of contents stored in the contents storage unit according to the environmental information obtained in the environment obtaining step; and
a recording step for recording the contents extracted in the contents extracting step to the storage medium of the portable terminal.

4. The contents recording method according to claim 3, wherein
the environment obtaining step obtains weather information as the environmental information.

5. A program for a computer to execute contents recording processing for recording a part of a plurality of kinds of contents stored in a contents storage unit to a storage medium of a portable terminal by a recording unit, wherein the contents recording processing includes:
environment obtaining processing for obtaining environmental information indicating a surrounding environment through an environment obtaining unit;
contents extracting processing for extracting contents from a plurality of kinds of contents stored in the contents storage unit according to the environmental information obtained by the environment obtaining processing; and
recording processing for recording, by the recording unit, the contents extracted by the contents extracting processing to the storage medium of the portable terminal.

6. A storage medium which can be read out by a computer to which the program according to claim 5 is recorded.
